(19) United States
(12) Patent Application Publication
(10) Pub. No.: US 2007/0063981 A1
(43) Pub. Date: Mar. 22, 2007

(54) System and method for providing an interactive interface

(76) Inventors: Tinsley A. Galyean III, Cambridge, MA (US); Henry Kaufman, Cambridge, MA (US)

Correspondence Address: GAUTHIER & CONNORS, LLP, 225 FRANKLIN STREET, SUITE 2300, BOSTON, MA, 02110, US

(21) Appl. No.: 11/228,790

(22) Filed: Sep. 16, 2005

(51) Int. Cl. G09G 5/00

(52) U.S. Cl. 345/173

(57) ABSTRACT

An interactive system is disclosed that includes an infrared source assembly for illuminating an exposed interface surface that is exposed to a user with substantially uniform infrared illumination, a diffuser for diffusing infrared illumination, and an infrared detection system for capturing an infrared image of the exposed interface surface through the diffuser. The infrared detection system provides image data that is representative of infrared illumination intensity of the exposed interface surface.

### BACKGROUND

The invention generally relates to data input devices for computer related applications, and relates in particular to interactive input/output devices for multi-user and/or multi-computer related applications.

Data display devices for computer related applications that may be viewed by a plurality of people at the same time generally include large format displays and other display projection devices. Input devices associated with such displays typically involve individual input units (such as hand held keypads) or touch screen output displays that may be physically touched by a user to thereby use their finger directly on the display screen.

The technologies by which such touch screens operate to identify a location on the screen that a person is touching, include a variety of techniques, such as capacitive sensing, optical beam interruption, optical beam generation, acoustic wave generation, and photographic imaging. Capacitive sensing involves having the exposed surface of the screen charged such that when a user touches the screen with his or her finger tip, the capacitive field in the area of the finger tip changes. The location of this slight change in capacitive field is identified, providing the location of the person's finger tip. For example, U.S. Pat. No. 6,825,833 discloses a system and method for locating a touch on a capacitive touch screen. Many automated bank machine display screens employ capacitive sensing for identifying user input locations on the screen.

Systems that employ optical beam interruption typically include an array of light emitting sources on two sides of the display, and complementary arrays of photo-detectors on the remaining two sides of the display. Each source/photo-detector pair provides an optical path that will be broken when a person's finger touches the screen. The paths in which the photo-detectors detect a break are identified, and this information is used to locate the position of the person's finger. For example, U.S. Pat. No. 4,855,590 discloses a touch input device that includes an array of infrared light emitting diodes (LEDs) on two sides of a display, and an array of photodetectors on opposing sides of the display.

Other touch sensitive systems employ an optically conductive film overlying a display. When a person presses a location on the film, light enters the film and then becomes trapped within the film, e.g., by total internal reflection. Sensors are positioned along two or more edges to determine the location of the depression through which ambient light entered the film. For example, U.S. Pat. No. 6,172,667 discloses optically-based touch screen input device that employs such an optically conductive film overlying a display.

Systems that employ acoustic wave generation are similar to those employing optical beam generation in that the user's finger causes an induced acoustic wave that travels toward the edges and is detected at two to four of the edges.

Each of the above systems, however, typically requires that only one user at a time touch the screen. Moreover, even if such systems were able to detect two independent touches at approximately the same time, it would likely fail if the two or more users touch a screen at the same time along a horizontal or vertical line on the screen. If two users touch a screen of the above technologies at the same time along such a line, the system will typically only register the first person's initial contact with the screen. Such systems also cannot accommodate changes in the input such as may occur if a person leaves their finger on the display for an extended period of time.

Systems that involve photographic imaging employ a camera to detect the location of a person or part of a person, such as a location and orientation of their finger. Such camera-based systems typically provide a series of digital frame output data to a computer image processing system. For example, U.S. Pat. No. 5,917,490 discloses an interactive processing system that includes a camera that records the movements of a user in a defined environment. Such a system, however, must accommodate changes in the environment, as well as changes in the output display itself. Moreover, it may be difficult for such a system to distinguish a touch of an input screen from a person's finger that is held slightly away from the input screen.

Additionally, U.S. Published Patent Application 2004/0183775 discloses an interactive environment that includes a projector that may be mounted on a ceiling, and a camera that captures image data regarding the position of a subject within the environment. The projector is disclosed to project visible or infrared illumination. Such a system may also experience difficulty, however, discerning between fine movements of a user, such as touching or not quite touching an input screen.

There remains a need therefore, for an improved interactive display system that permits multiple users to interact with a display system at the same time.

### SUMMARY

In accordance with an embodiment, the invention provides an interactive system that includes an infrared source assembly for illuminating an exposed interface surface that is exposed to a user with substantially uniform infrared illumination, a diffuser for diffusing infrared illumination, and an infrared detection system for capturing an infrared image of the exposed interface surface through the diffuser. The infrared detection system provides image data that is representative of infrared illumination intensity of the exposed interface surface.

In accordance with another embodiment, the invention provides an interactive system that includes an interface surface through which a user may interact with the interactive system from an exposed side of said interface surface, an infrared source assembly for illuminating the interface surface with substantially uniform infrared illumination from an interior side of the interface surface, and an infrared detection system for capturing an infrared image of the exposed surface from the interior side of the interface surface. The infrared detection system provides image data that is representative of infrared illumination intensity of the exposed surface.

In accordance with another embodiment, the invention provides a method of providing an interactive system that includes the steps of providing an exposed interface surface through which a user may interact with the interactive system, illuminating the exposed interface surface with substantially uniform infrared illumination, capturing an infrared image of the exposed surface and producing captured infrared image data, and filtering background data from the captured infrared image data.

### BRIEF DESCRIPTION OF THE DRAWINGS

The following description may be further understood with reference to the accompanying drawings in which:

FIG. 1 shows an illustrative diagrammatic functional view of a system in accordance with an embodiment of the invention;

FIG. 2 shows an illustrative diagrammatic side view of a system in accordance with an embodiment of the invention;

FIG. 3 shows an illustrative diagrammatic top view of the system as shown in FIG. 2;

FIGS. 4A-4C show illustrative diagrammatic flowcharts of the operational steps of a system in accordance with an embodiment of the invention;

FIGS. 5A and 5B show illustrative diagrammatic views of the underside of two objects that may be used with a system in accordance with an embodiment of the invention;

FIG. 6 shows an illustrative diagrammatic view of a screen assembly in accordance with a further embodiment of the invention; and

FIG. 7 shows an illustrative diagrammatic view of a multi-user system in accordance with a further embodiment of the invention.

The drawings are shown for illustrative purposes only.

### DETAILED DESCRIPTION OF THE ILLUSTRATED EMBODIMENTS

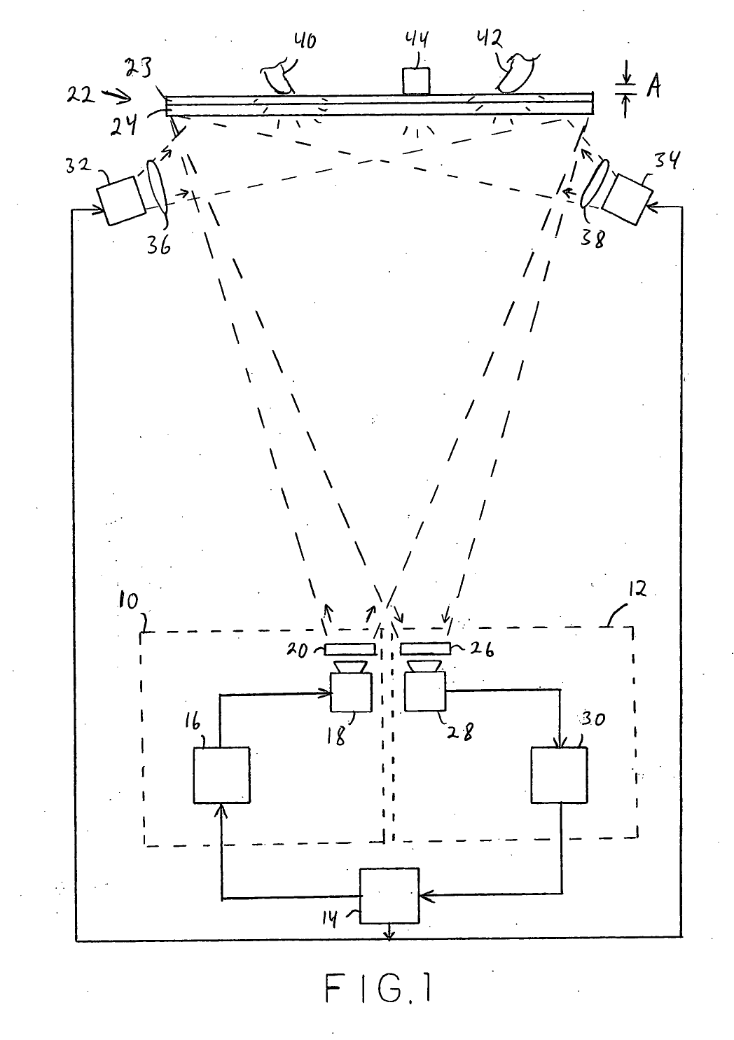

As shown in FIG. 1, a system in accordance with an embodiment of the invention includes a display output system 10, a touch input system 12, and a computer processing system 14 for executing an application program that presents output data to the display output system 10, and receives input data from the touch input system 12.

The display output system 10 includes a display controller 16, a display projector 18, and an infrared filter 20 for removing infrared light from the display output. The display projector projects a display image onto the underside of a screen assembly 22. The display image may include, for example, a projected image of a computer screen for a plurality of people to simultaneously view from the opposite side of the screen assembly 22. The system may be constructed such that the screen assembly 22 may provide either a table surface around which a plurality of people may gather, or a wall mounted hanging display screen that a plurality of people may view simultaneously. The screen assembly 22 may include a support material 23, for example, glass or a polymer-glass combination, and a diffuser material 24 that provides a non-specular surface having a matte finish. The diffuser material, for example, may be formed of a polyester film such as MYLAR® film sold by the E.I. DuPont deNemours & Co. of Wilmington, Del. The support material 23 and diffuiser material 24 should be at least substantially transparent. The diffuser material 24 should provide a desired amount of diffuision of infrared illumination that passes through the support material 23 as discussed further below.

The touch input system includes an infrared pass filter 26 that permits only infrared light to pass through the filter, an infrared receiving camera 28 for receiving infra illumination, and a touch input controller 30. The camera 28 may be either designed specifically for receiving infrared illumination, or may provide a wide band of spectral sensitivity with a low level of reception of infrared illumination that is sufficient for use in the invention as discussed below. While near field infrared light is used in this implementation, any non-variable light could be used.

The system also includes infrared sources 32 and 34 that together with output lenses 36 and 38 provide a substantially uniform infrared illumination field across the screen assembly 22. The infrared sources may be provided as arrays of LED sources along any of 1-4 sides of the display screen unit. For example, a system may include arrays of LEDs at each of two opposing sides of the screen assembly 22 as shown in FIG. 1, wherein each array includes several rows of tightly positioned LEDs (e.g., two or three rows each). In accordance with another embodiment, infrared sources may be used that include incandescent (e.g., tungsten, halogen, etc.) light sources together with infrared-pass filters. In further embodiments, the infrared sources may be positioned in a variety of locations including, for example, near the camera.

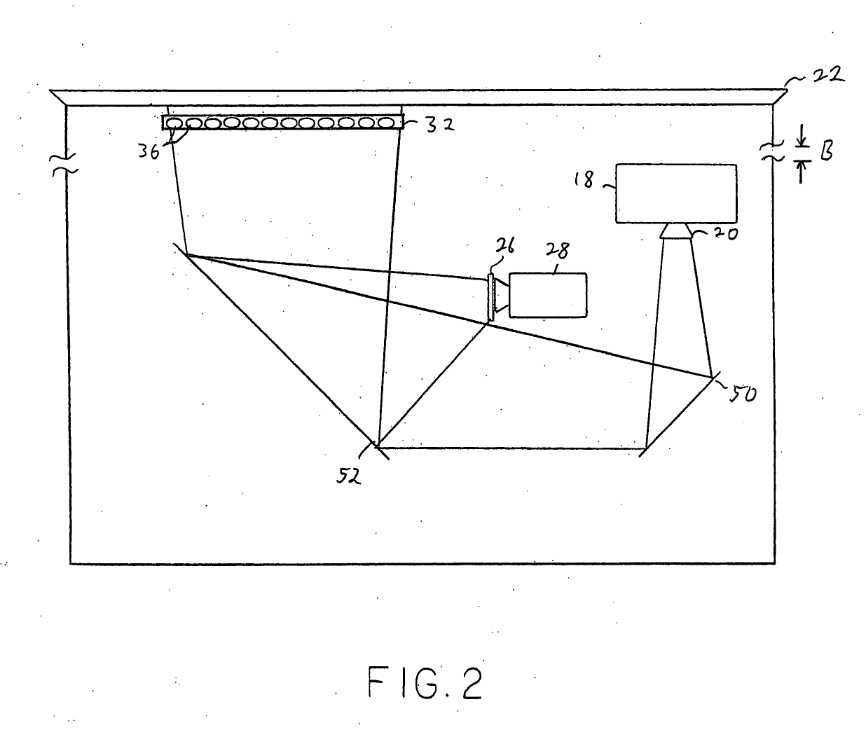

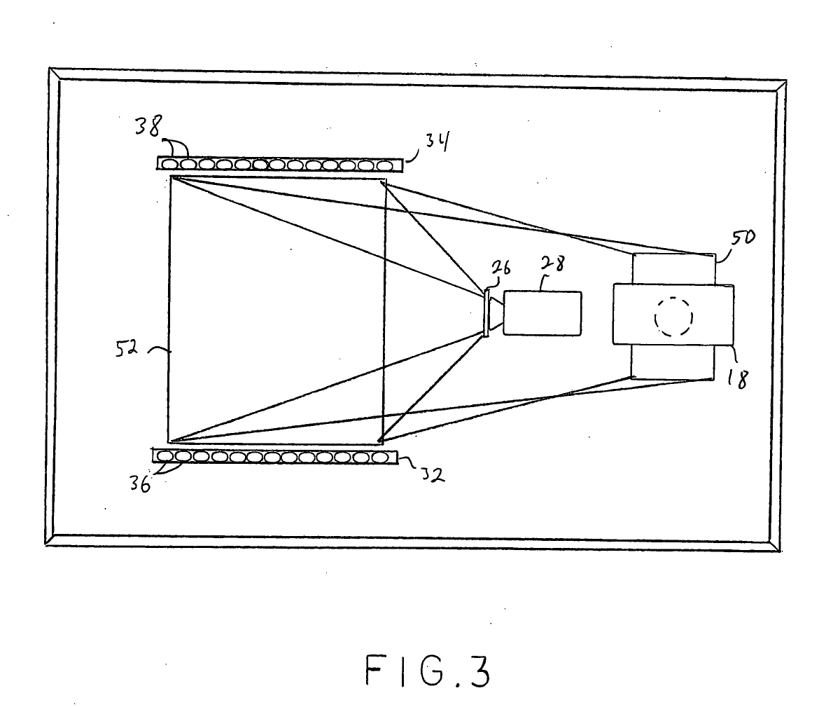

As shown in FIGS. 2 and 3, an actual display unit may include mirrors 50 and 52 to provide the projector and camera focal areas to be directed toward the screen assembly 22. In particular, the projector 18 may direct a projected image onto the screen assembly 22 via mirrors 50 and 52, while the camera 28 may capture image frames of the screen assembly 22 via mirror 50 as shown in FIGS. 2 and 3. The size of the projected image (as well as the captured image) may also be adjusted by changing the distance of the screen assembly 22 from the mirror 52 as shown at B in FIG. 2.

During use, the projector 18 of the display output system 10 projects a display image of a computer output screen onto a first side of the screen assembly 22. The display image is viewable through the screen assembly 22 by one or more users. Any infrared illumination from the display projector 18 is removed (if desired) by the infrared filter 20. The infrared sources 32, 34 provide a substantially uniform infrared illumination across the first side of the screen assembly 22. The infrared camera 28 of the touch input system 12 receives only infrared illumination (due to the infrared pass filter 26), and provides images to the touch input controller 30.

When a person places their finger 40 on the outer exposed surface of the screen assembly 22, the touch input controller 30 will detect the presence of an intensity disturbance in the infrared illumination field at the location of the person's finger 40. The person may, for example, point to a particular item on the display image much as one might use a computer mouse to do in a conventional personal computer. The system may be initialized and calibrated to synchronize the focal field of the projector 18 with the field of view of the camera 28 by having the user touch specific places on the screen at start-up.

During use, two or more people may simultaneously point (e.g., 40, 42) to different portions of the display image. In further embodiments, one or more objects 44 may be positioned on the exposed surface of the display assembly 22. The diffuiser material 24 provides a projection surface as well as a diffusing surface with the quality that that the person's finger must be sufficiently close to the screen assembly 22 for the intensity disturbance of the infrared illumination to be sufficiently well defined. When the finger is more than a certain distance away from the screen assembly (e.g., as shown at A in FIG. 1), then the reflected infrared illumination intensity in the area of the finger is too dispersed, so controller 30 can advantageously reject this blurred intensity area. The ability of the diffuser to disperse or blurr the transmitted light as a function of distance is used to advantage in order to detect when a finger or object is in contact or nearly in contact with the surface as opposed to just a few inches away from the surface. The image processing software performs a high-pass filter on the incoming image signal in order to reject any blurred objects. The high-pass filter brightens sharp edges and removes constant or slowly-changing intensity regions (such as blurred shapes). This step effectively removes from consideration any bright objects that are further than small distances from the surface. The high-pass step also helps to make the system robust to changes in the ambient room illumination.

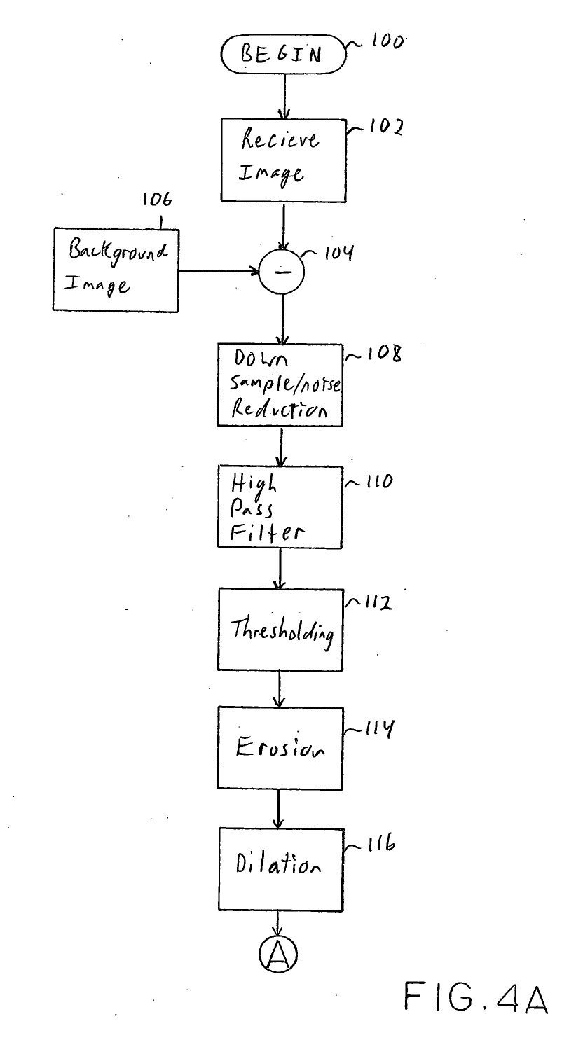

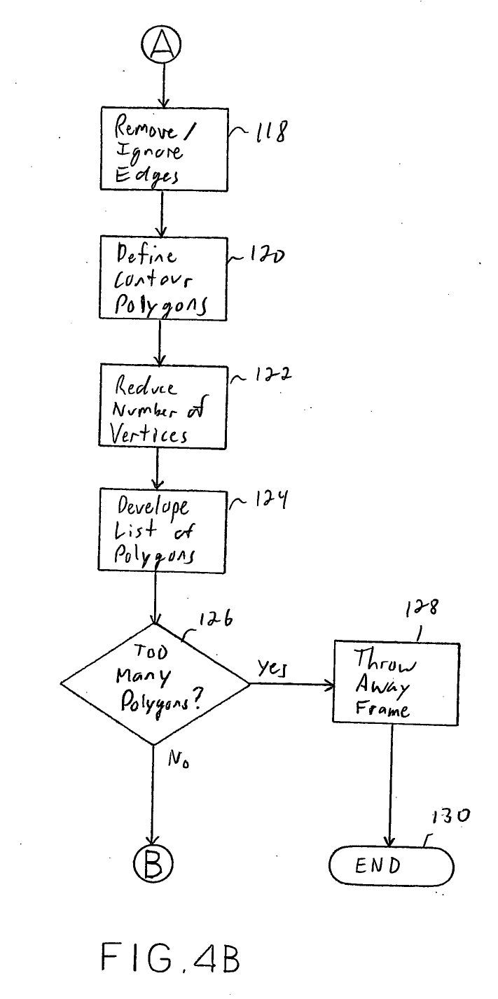

Each image frame may include image data of, for example, 640 by 520 pixels with 8 bits of data at each pixel, The system must quickly process the data without compromising the integrity of the output of the touch input system in generating actual event data (of, for example, a touch by a user). As shown in FIGS. 4A-4C, the system begins (step 100) each iteration by receiving image frame data representative of a current image frame from the camera (step 102). The small percentage of raw image frame data is averaged (step 104) into the dynamically updated background image frame (step 106) using a weighted averaging technique. For example, the background may be given a weight of above 50/100, for example 75/100 to 99/100, while the current image frame data is given a weight of the difference between 1 and the weight of the background data. For example, a background weight may be 99% while a current image frame may be given a weight of 1%. After many frames, the constant part of the frame data that was formerly the current image data will eventually become the background image data. This form of background averaging will exponentially fade current image in with the background over time. In further embodiments, the background data may be the windowed average of the previous 10, 100 or 200 image frames. If the speed of the processing of the frame image data is maintained relatively high, such a background weighted subtraction technique will enable the system to quickly adjust to any new equilibrium condition, even at initial startup irrespective of the initial background data. This adjustability enables the system to be robust to illumination changes in the environment.

If the background image is to be given a very long half-life for a slow fade time so that transient surface contacts do not fade in too quickly, the weight must be small so that it takes a long time for the current image to fade in. It is reasonable to give a weighting of less than 1/256, which is smaller than a one bit unit value of an eight bit image pixel value. Thus, in order to perform the above weighted subtraction on two eight bit numbers (e.g., per pixel), it is desirable to permit conversion to a 16 bit sum in order to maintain accuracy and avoid artifacts. Simply converting this sum back to an 8 bit number (e.g., by shifting the decimal and then rounding up or down based on the traditional above or below 0.5 approach, has been found to yield results that are not fully satisfactory. Applicants have discovered, however, that substantial accuracy may be maintained by performing a rounding (up or down) function based not on the value 0.5 but for each iteration basing the rounding (up or down) on a random number between 0 and 1 carried to 8 bits. The result of this random generation of a rounding trigger has been found to yield an accuracy of the image data well beyond the actual 8 bits of image data used for further processing, possibly adding the equivalent of 4 bits of resolution due to the random distribution of error artifacts caused by the rounding operation.

In another embodiment, floating point values may be used for the background image (and other image buffers) to allow more accurate representations. On some CPU architectures, floating point operations are of comparable speed with integer operations, so there is no significant cost to performing image processing in floating point.

After the background image reaches a steady state because the environment has not moved or changed for a long enough time, the background represents the state of the display surface while no hand or object is in contact with the surface. When the environment changes the system described above will adjust dynamically over time. This background image is subtracted from the raw image frame yielding a difference image (Step 104). The subtraction removes constant parts of the image revealing only what has changed, in particular fingers in contact with or near the surface will show up, as well as other transient and reflective objects. Because the infrared illuminates the objects, the objects will be brighter than the surface is when nothing is in contact with the surface, so objects will be brighter than the background image.

The system then performs a number of image processing functions as discussed below that may be performed using a variety of standard image processing tools such as, for example, those distributed by the Computer Vision Group of the Carnegie Mellon University in Pittsburgh, Pa. (OpenCv). The raw difference image is smoothed in various ways in order to reduce noise. In one embodiment, a smoothing filter is applied, while in another embodiment, the image may be reduced in resolution by averaging groups of pixels. The system then performs a high pass filter function (step 108) on the image frame data using, for example, a conventional Laplace transform algorithm. The high-pass operation finds the edges and rapid intensity changes and features that are well defined such as when a finger is touching the screen. When the finger is moved away, it will become blurry and hence be filtered out of this pass. The system then crops the size of the image (step 110) by about 3 to 5 pixels on all sides to remove the borders. The system then performs a thresholding function (step 112) to identify pixels that are above a defined threshold. The pixels that are above the defined threshold are referred to in the text below as being on, while the remaining pixels are considered to be off. The system then performs an erosion function (step 114) followed by a dilation function (step 116) to remove very small areas of above threshold intensity pixels, i.e., small groups of on pixels. This is achieved by first eroding all of the groups of on pixels by, for example, one or two pixels around the edges of each group. The very small groups will then disappear. Each remaining group is then dilated by, for example, one or two pixels around the edge of each group of on pixels. The erosion/dilation operators serve to reduce noise in the detection (such as from occasional static in the image that may be enhanced by the high-pass operation) thereby reducing false-positive detection of touches.

The system then removes any remaining noise pixels from the edges of the image (step 118), and then computes contours of the shape of each connected group of on pixels (step 120). These contours are represented as lists of connected vertices, and the number of vertices for each group of on pixels is then reduced (step 122) by replacing sets of two or more adjacent vectors by a single output vertex when the three or more adjacent vertices are very similar or collinear to one another and/or when one or more line segments in the set is very short. Other polygonal vertex reduction techniques may be used, such as the Teh-Chin algorithm, using L1 curvature provided by the OpenCv Image Processing library (C. H. Teh, R. T. Chin. On the Detection of Dominant Points on Digital Curves.—IEEE Tr. PAMI, 1989, v. 11, No. 8, p. 859-872). The output of this stage (step 124) is a simplified list of polygons outlining each contour shape (also called a blob).

Each group of on pixels is now represented by a set of polygons that define the group's shape. The system then develops list of these shapes or polygons, and if the image frame includes too many polygons (step 126), then the image frame data is thrown out (step 128) and the processing of that image frame data is ended (step 130). The condition of there being too many polygons in the image frame may occur, for example, if the threshold is set too low or if the screen assembly is too brightly illuminated with infrared illumination. This may result in many blobs (tens or hundreds) appearing in the processed frame until the background or the camera settings re-adjust to the new light levels.

If there are not too many polygons in the image frame (step 126), the system then characterizes each polygon using, for example, translation invariant, non-orthogonal centralized moments such as Hu moments (step 132) (M. Hu. Visual Pattern Recognition by Moment Invariants, IRE Transactions on Information Theory, 8:2, pp. 179-187, 1962). The shape and area of each polygon may now be evaluated, and the system now determines whether any of the shapes is too large (step 134) and if so, the system removes the data corresponding to the shapes that are determined to be too large (step 136). The system then determines whether any of the shapes is too small (step 138) and if so, the system removes the data corresponding to the shapes that are determined to be too small (step 140).

The system then seeks to identify each shape (step 142) by correlating the shapes with a set of known profiles, such as a human finger 40, 42 or other object 44 that may be placed in contact with the screen assembly 22. Any remaining pixel groups (or blobs) that are very close to one another are then merged into composite shapes (step 144). The collected list of shapes is reported as an event (step 149).

To provide higher-level events to end-user applications such as mouse-down, mouse-move, and mouse-up that correspond with the moment of finger contact, finger motion, and finger removal, respectively, the polygon shapes must be tracked from frame to frame over time. After the image processing steps, every frame presents a new set of polygons that is compared (step 146) with the previous frame's set of tracked polygons. The polygons are compared for their position, size, and other attributes such as the Hu moments. If two polygons have similar shape attributes and are within a reasonable distance (that would be appropriate for a reasonable speed for a person to move their finger within one frame), then the two polygons are considered a match. For a matched polygon, a mouse-move event is reported (step 148) with the matched polygon's ID (identifier).

If no match is found for a new polygon from the previous frame's polygons, then it is assumed that the object or finger was removed from the display surface. The tracking algorithm may wait for a certain number of non-matched frames to pass without a match to allow for transient dropout frames. When enough frames have elapsed without a match for a polygon, a mouse-up event is reported. If new polygons are found that have no match to previous polygons, then they are assigned new unique ID's and they are reported as mouse-down events. Using this technique, it is possible to use one's finger directly as a mouse in a familiar way. Part of the invention is a software emulator for the usual mouse device which interacts with standard PC software. It is also possible to use multiple fingers simultaneously in novel gesture-related user interfaces. The process for that image frame ends (step 130). The system then repeats the entire process for the next image frame.

Upon initialization of the system, the background image may be any of a variety of sets of image data, e.g., all zeros or the first frame captured by the camera. Because the system iteratively cycles for every frame captured, the weighted background averaging will eventually (e.g., after several seconds or minutes) normalize to provide an accurate representation of the unchanging background.

The mapping of the display image to the image frame data captured by the camera may be finely adjusted during the calibration phase by having a user point to specific marks on the display image at designated times. By knowing where the points were displayed and where the touches occurred for at least four points, a perspective mapping may be computed to map from sensed touch locations in the camera image's coordinates to the projector's display coordinate. In another embodiment, the visible-block/infrared filter may be removed from the camera and the projector may project patterns used to define a mapping automatically.

During use, the system may also turn off the arrays of infrared emitting LEDs 32, 34 in order to ascertain the amount of infrared illumination in the general environment of the screen assembly without the LEDs 32 and 34. This information may be used to adjust the threshold and other information during image processing.

In other embodiments, the system may provide that the infrared sources 32 and 34 provide infrared illumination in a first range of infrared frequencies. The system may further include a second infrared filter that passes to a second infrared camera only infrared illumination in a second frequency range of infrared illumination that does not overlap with the first frequency range of infrared illumination. Assuming that any ambient infrared illumination will provide equal intensity in both the first and second ranges, the background infrared illumination in the environment may be continuously monitored and subtracted based on the measurement of infrared illumination in the second range of frequencies.

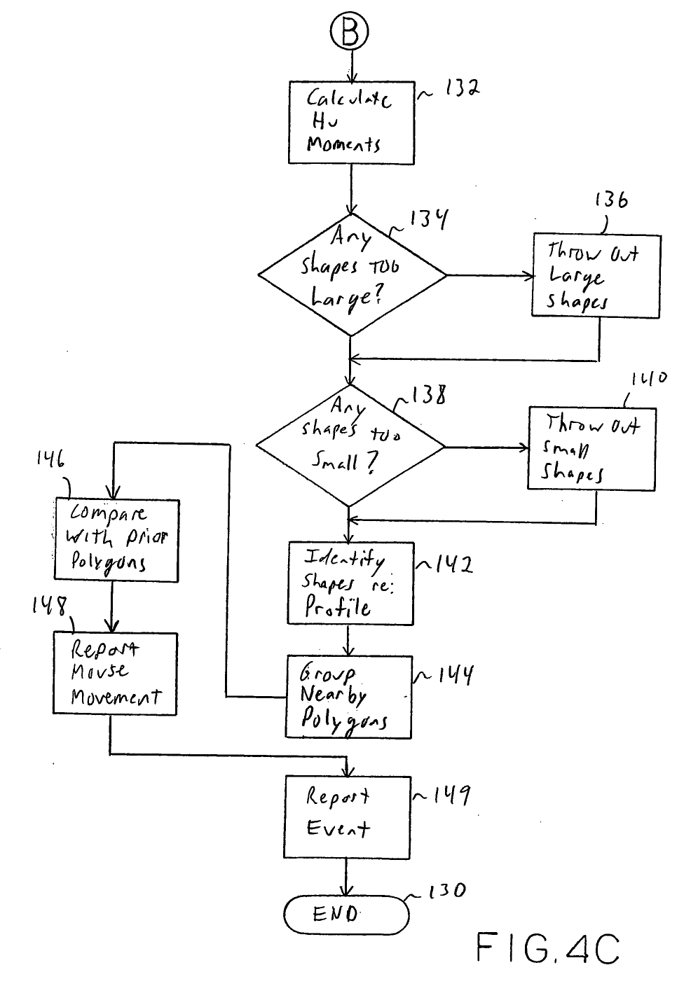

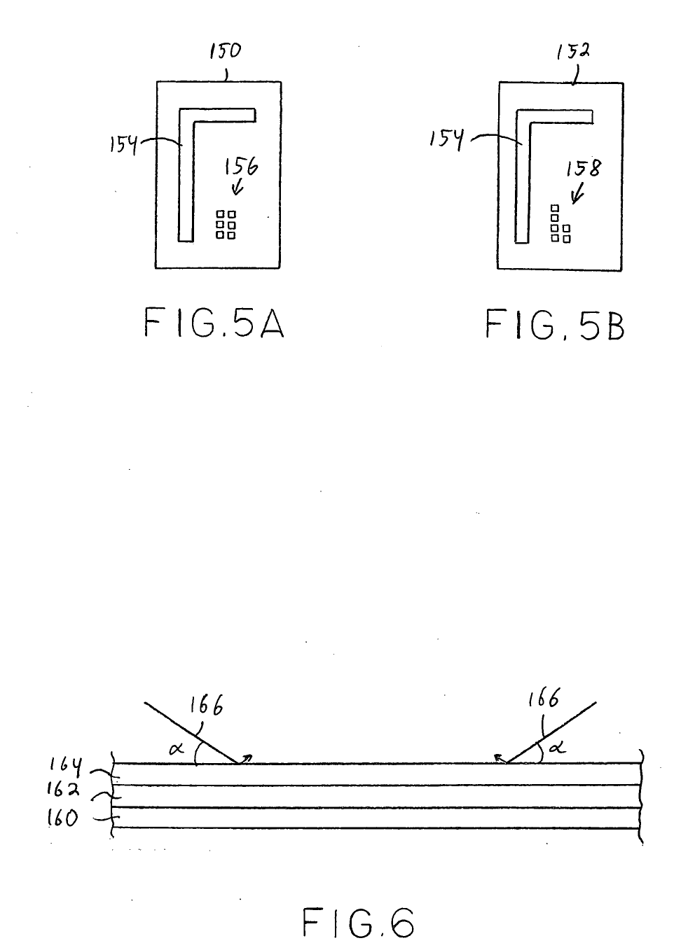

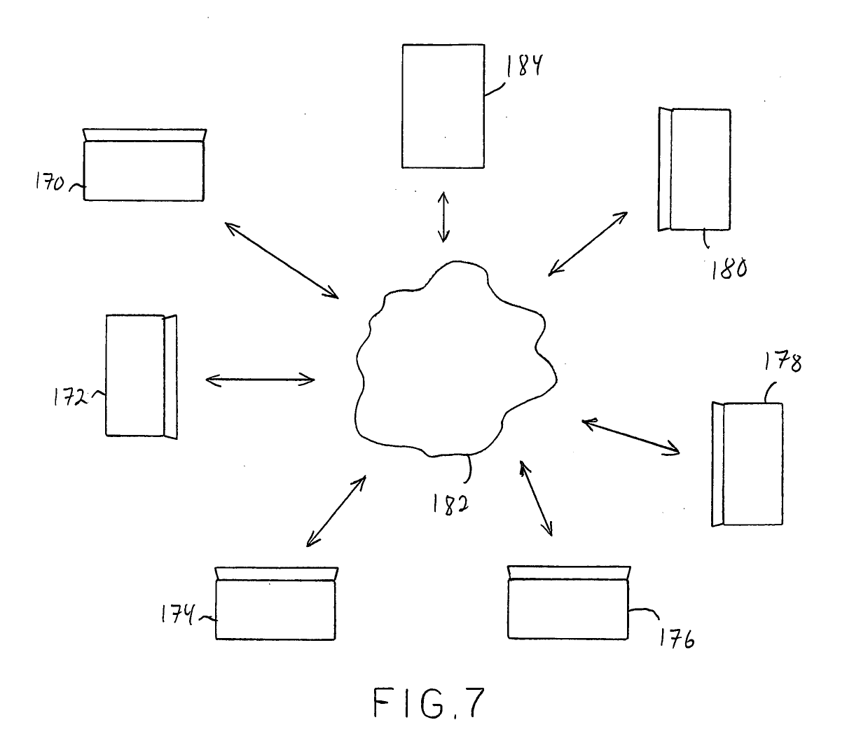

As shown in FIGS. 5A and 5B, any objects 150, 152 may include on the bottom of the object, an object type infrared reflecting code 154 that indicates the type of object, as well as a set of infrared reflecting key codes 156, 158 that will identify each actual object uniquely. These code shapes may be identified as discussed in step 142 above to thereby uniquely identify each object and its orientation.

In addition to a layer of diffuser material 160 and support material 162, a screen assembly may also include one or more transparent layers of material that reduce glare, such as for example, dichroic material 164 as shown in FIG. 6. A dichroic film 164 for example, may be designed to reduce glare at a defined angle α as shown at 166. Infrared illumination at (as to a lesser extend near) the angle α would be blocked from passing through the screen assembly. This may help reduce the effect of infrared illumination from sunlight that enters a room through a window. In further embodiments, a plurality of such films may be used, each having a different blocking angle α, α₂, α₃ etc. to cover a wider range of angles. Alternatively, infrared blocking films may be placed on any windows.

In further embodiments, the system may include a plurality of projector/input devices 170, 172, 174, 176, 178 and 180, some of which may be provided as tables, some of which may be provided as wall mounted units. Each projector/input device includes a display output system and a touch input system. The system may also include a network 182 (e.g., a wireless network), as well as a central processor system 184 that executes an application program. The central processor also provides a common output display to each device and receives input from each device. Each user, therefore, may view the same output display, and may simultaneously input data to the system via the screen assembly. Changes made by each user may also be presented on the displays of the other users.

In further embodiments, the infrared receiving camera 18 may include two independent image recording arrays (e.g., CCD arrays), one sensitive to a first range of infrared illumination (e.g., 800 nm-850 nm), and the sensitive to a second range of infrared illumination (e.g., 850 nm-900 nm). The sensitivity may be achieved by the use of specific blocking filters that pass only the respective range of infrared illumination to the associated CCD array. Because the infrared sources 32 and 34 would be known to be within one but not both of the ranges (e.g., 825 nm), the system could identify infrared illumination that is detected by the other recording array as being background infrared illumination. This background illumination could then be subtracted from the recorded image for the system based on the assumption that background illumination (from for example the sun) is likely to include equal amounts of infrared illumination in both ranges.

Those skilled in the art will appreciate that numerous modification and variations may be made to the above disclosed embodiments without departing from the spirit and scope of the invention.

What is claimed is:

1. An interactive system comprising:
an source assembly for illuminating an exposed interface surface that is exposed to a user, with substantially uniform illumination;
a diffuser for diffusing illumination;
an detection system for capturing an image of said exposed interface surface through said diffuser, said detection system providing image data that is representative of illumination intensity of said exposed interface surface; and
a data filter for filtering said image data to provide filtered image data that identifies areas that include rapid transitions in intensity at their edges.

2. The interactive system as claimed in claim 1, wherein said exposed interface surface is provided on an exposed surface of said diffuser.

3. The interactive system as claimed in claim 1, wherein system further includes a display assembly for displaying a display image at said exposed interface surface, and calibration means for calibrating the display image on the exposed interface surface with the detection system.

4. The interactive system as claimed in claim 1, wherein said diffuser is interposed between a user of the interactive system and both the detection system and the source assembly.

5. The interactive system as claimed in claim 1, wherein said interactive system further includes a control system that is coupled to said detection system, said control system being capable of detecting a plurality of areas in said exposed interface surface that include illumination intensity greater than a threshold illumination intensity at substantially the same time.

6. The interactive system as claimed in claim 5, wherein said control system captures a plurality of successive sets of image data, each set of image data being representative of illumination intensity of an area of said exposed interface surface at a particular time.

7. The interactive system as claimed in claim 6, wherein said control system averages a current image with a stored background images.

8. The interactive system as claimed in claim 1, wherein said detection system includes means for separately detecting illumination in each of two independent ranges of frequencies of illumination, said source assembly providing illumination within one but not both of said independent ranges of frequencies of illumination.

9. The interactive system as claimed in claim 1, wherein said interactive display system further includes a selective filter for removing ambient illumination that approaches said selective filter at an angle of α.

10. The interactive system as claimed in claim 1, wherein said source assembly, said diffuser, and said detection system are included within an interactive unit, and wherein said interactive system further includes a plurality of additional interconnected interactive units, each said additional interactive unit including a source assembly, a diffuser, and a detection system.

11. An interactive system comprising:
an interface surface through which a user may interact with said interactive system from an exposed side of said interface surface;
an infrared source assembly for illuminating said interface surface with substantially uniform infrared illumination from an interior side of said interface surface; and
an infrared detection system for capturing an infrared image of said exposed surface from said interior side of said interface surface, said infrared detection system providing filtered image data that is representative of infrared illumination intensity of said exposed surface in areas that include rapid transitions in intensity at their edges.

12. The interactive system as claimed in claim 11, wherein said interface surface is provided by a diffuser.

13. The interactive system as claimed in claim 11, wherein system further includes a display assembly for displaying a display image at the exposed side of said interface surface, and calibration means for calibrating the display image on the exposed side of said interface surface with the infrared detection system.

14. The interactive system as claimed in claim 11, wherein said interactive system further includes a control system that is coupled to said infrared detection system, said control system being capable of detecting a plurality of areas in said exposed interface surface that include infrared illumination intensity greater than a threshold illumination intensity at substantially the same time.

15. The interactive system as claimed in claim 14, wherein said control system captures a plurality of successive sets of image data, each set of image data being representative of infrared illumination intensity of an area of said exposed side of said interface surface at a particular time.

16. The interactive system as claimed in claim 15, wherein said control system averages a current image with a stored background image.

17. The interactive system as claimed in claim 11, wherein said infrared detection system includes means for separately detecting infrared illumination in each of two independent ranges of frequencies of infrared illumination, said infrared source assembly providing infrared illumination within one. but not both of said independent ranges of frequencies of infrared illumination.

18. The interactive system as claimed in claim 11, wherein said interactive system further includes a selective filter for removing ambient infrared illumination that approaches said selective filter at an angle of α.

19. The interactive system as claimed in claim 11, wherein said interface surface, said infrared source assembly, and said infrared detection system are included within an interactive unit, and wherein said interactive system further includes a plurality of additional interconnected interactive units, each said additional interactive unit including an interface surface, an infrared source assembly, and an infrared detection system.

20. A method of providing an interactive system, said method comprising the steps of:
providing an exposed interface surface through which a user may interact with said interactive system
illuminating said exposed interface surface with substantially uniform infrared illumination;
capturing an infrared image of said exposed surface and producing captured infrared image data;
filtering background data from said captured infrared image data; and
applying a high pass filter to said captured image data to provide filtered image data that identifies areas that include rapid transitions in intensity at their edges.

21. The method as claimed in claim 20, wherein said step of filtering background data from said captured infrared image data involves averaging a current image with a stored background image.

22. The method as claimed in claim 20, wherein said step of filtering background data from said captured infrared image data involves subtracting a background image from a current image, wherein said background image is captured for a range of frequencies that does not include the frequency of the infrared illumination.

23. The method as claimed in claim 20, wherein said step of capturing said infrared image of said exposed surface for each of the plurality of times includes capturing said infrared image of said exposed surface through a diffuiser.

24. The method as claimed in claim 23, wherein said method further includes the step of applying a high pass filter to said captured infrared image data.

25. The method as claimed in claim 20, wherein method further includes the steps of displaying a display image at the exposed interface surface, and calibrating the display image on the exposed interface surface with an infrared detection system.

26. The method as claimed in claim 20, wherein said method further includes the step of detecting a plurality of areas in said exposed interface surface that include infrared illumination intensity greater than a threshold illumination intensity at substantially the same time.

27. The method as claimed in claim 20, wherein said method further includes the step of removing from said captured infrared image data ambient infrared illumination that approaches said selective filter at an angle of α.

28. The interactive system as claimed in claim 1, wherein said data filter includes a high pass filter.

29. The interactive system as claimed in claim 1, wherein said data filter performs a Laplace transform on said image data.

30. The method as claimed in claim 20, wherein said step of applying a high pass filter includes performing a Laplace transform on said image data.
